(19) United States
(12) Patent Application Publication
(10) Pub. No.: US 2006/0085843 A1
(43) Pub. Date: Apr. 20, 2006

(54) Computerized Authentication System

(76) Inventor: DANIEL WILLIAM ONISCHUK, EDMONTON (CA)

Correspondence Address: DAN ONISCHUK, 9628 100A ST, EDMONTON, AB, T5K 0V8, CA

(21) Appl. No.: 11/163,962

(22) Filed: Nov. 4, 2005

Related U.S. Application Data
(63) Continuation of application No. 11/160,003, filed on Jun. 4, 2005.
(60) Provisional application No. 60/521,626, filed on Jun. 7, 2004.

(30) Foreign Application Priority Data
Jun. 7, 2004 (CA) 2470096

(51) Int. Cl. H04L 9/32

(52) U.S. Cl. 726/4

(57) ABSTRACT

One application of this invention is where, a cashier at a bank or business can use an optical barcode scanner to obtain and transmit a registered ID on any currency, transmit a verification request to a Registration Authority, and receive a reply to determine whether the RSID is genuine, under surveillance, or has been previously reported as being fraudulently reproduced (counterfeited). A computer system, is used to track unique identifiers of items to reduce losses due to fraud. A unique identifier (RSID) is assigned to each item (such as, but not limited to: money order, paper currency). The RSID is used to authenticate the item is valid for use. As counterfeit RSIDs are detected, they are added to a computer database, enabling comparison of an RSID to all of the already known and counterfeit items RSID's. The RSID may further be used to identify the location of the item. By identifying the location where the request for authentication occurred, any subsequent request for the same RSID is assessed by people or computers executing tracking and assessment software programs. The RSID requestor is compared to other recent requests for the same RSID. If the time and physical distance between locations are reasonable as per computer program models and data, then no action is taken; however, if a RSID is reported at nearly the same time in distant places, or outside a reasonable transportation time limit for the last known reported location of the item, then an alert message is sent to the requester indicating the item may be counterfeit, so that the requestor more closely inspects the item.

### TECHNICAL FIELD

Data Processing for Business, Governments, Museums, Public.

Technical Problem resolved: Counterfeit stock certificates, bonds, currency, documents and transactions create economic loss. A major problem is there is no expedient manner to rapidly verify the authenticity of currency, documents, stock certificate, bonds, transactions, ballots, artwork or any other items.

### INDUSTRIAL APPLICABILITY

Governments, Banks, Museums, Law Enforcement Agencies, Businesses and law abiding People would benefit significantly.

### DISCLOSURE

At least one unique identifier (RSID) is assigned to, and is an integral part of, each item of stock certificate, bond, monetary currency, document, artwork, object or transaction (hereafter referred to as “Item”). The RSID is used to authenticate the Item is valid and furthermore, not reported as lost, stolen, stored for safekeeping, or under other surveillance. The RSID could also be used to identify the location of an item. A computer system is used to track unique identifiers (RSID) for the purpose of fraud prevention. The computer system may be linked to other computer systems locally, within a state, nation, internationally or any combination of geographic regions or sub-regions.

By identifying the location where the request for authentication occurred, any subsequent request for the same RSID is assessed with regard to other requests for the same RSID. If the time and physical distance between locations are reasonable as per computer program models and data, then no action is taken other than to record the location of the requestor and the RSID submitted; however, if an RSID is reported at nearly the same time in distant places, or outside a reasonable time for movement from the last known reported location of the RSID, then an alert message is sent to the requestor (or item owner) indicating the item may be counterfeit (or missing), so that the requestor (or item owner) can more closely inspect the item or at least be made aware of the item's status. The location, time information may also be used for tracking an items path of travel or distribution. For example, to enable police to trace the extent of an outbreak of counterfeit currency or to trace the distribution of valid currency used to pay a ransom or used to purchase illegal or stolen goods as part of a intelligence gathering “sting” operation.

In the case of counterfeit RSIDs detected, they are added to at least one computer database, enabling any legitimate requestor to compare an RSID to all the already known counterfeited RSID's.

By encoding the RSID as a group of barcode symbols, hologram, or any other form appropriate to the currency and available technology, the requester could use a barcode scanner or credit card magnetic stripe scanner, such as those found at sales terminals of retail stores, with any other electronic or optical devices to transmit the RSID of any received item, along with some form of identification of the requestor. Messages regarding the quality of the RSID scan, the item status, error messages and other related information such as police contacts data would be transmitted to the requestor. A requester would also be given the means to report suspect or counterfeit items immediately or at a later time and date.

Requestors may also be provided with a telephone service, or, an Internet website service, to enable them to verify the authenticity of any item received, with the capability to report fraudulent or missing items. This would enable the general public to use this system as a public service paid by their tax dollars and regulated by various government(s) and law enforcement agencies.

In addition to the unique RSID(s), Security Elements may also be attached, embedded in or linked to the item for Authentication and Validation. For example, (but not limited to:) a Security Element may be a micro-miniature transmitter that provides identity or authenticity information. Using nanotechnology manufacturing techniques, electronic transmitters the size of a grain of sand are being made today. Other Security Elements may be comprised of any number of (but not limited to): symbolic codes, physical characteristics, physical structures, optical structures, optical devices, electronic devices, electronic structures, magnetic fields, magnetic devices, electromagnetic fields, electromagnetic waves, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing and any other physical, mechanical, electromagnetic, optical, chemical or biological structures, devices, or components.

Random Symbolic Identity (RSID)—Mathematics of Binary Encoding

The purposes of the RSID is to enable verification by computer of the currency identity as an authentication test of validity and to prevent counterfeiting of a diverse series of currency. Using 16 or more concatenated symbolic characters as a Random Symbolic ID (RSID) could provide unique identity security of every single Item within group and subgroups of similarly classified Items.

To understand how this is so, consider that 256 symbolic characters can be represented by 256 unique combinations of eight (or more) computer binary digits ranging from 00000000 to 11111111.

Each character symbol has one specific binary digit patter with a numeric equivalent value (Base 10 counting).

| ASCII characters | Binary representation | Base 10 value |
|---|---|---|
| A | 01000001 | 65 |

| | | |
|---|---|---|
| B | 01000010 | 66 |

Concatenating characters increases the number of binary digits that can be interpreted to represent larger binary and numeric (base 10) numbers, as well as for a plurality of counting base methods such as base 8 (octal), base 16 (hexadecimal), etc.

| ASCII characters | Binary representation | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a corresponding unique, equivalent numeric value that can be used to identify a specific sequence of concatenated symbolic characters. Therefore each and every unique concatenation of symbolic characters also has a unique numeric value associated only with that specific combination of symbolic characters when using a consistent method of assigning each character symbol to only one binary value.

| Characters | Binary Digits | Total Binary Digits | Max Value |
|---|---|---|---|
| 8 | ×8 binary | 64 | 1.8 × 10E19 |
| 16 | ×8 binary | 128 | 3 × 10E38 |
| 24 | ×8 binary | 192 | 6 × 10E57 |
| 32 | ×8 binary | 256 | 1 × 10E77 |

To understand how large these numbers are, consider that everything is made of atoms. There are about 3×10E51 atoms on Earth; the entire Universe contains 10E78 to 10E81 atoms.

Note 1: INTERNET >http://mathforum.org/library/drmath/view/59178.html “ . . . the mass of the earth . . . about 6×10E27 grams. Pretend the earth is made up entirely of hydrogen atoms (since they are the lightest, so there would be more of those than the actual number of heavier atoms.). “One H atom weighs one atomic mass unit, 1.66×10E-24 grams. So the number of atoms in the earth can be no more than 6×10E27 g/earth/1.66×10E-24 g/atom=3.6×10E51

Note2: INTERNET >http://pages.prodigy.net/jhonig/bignum/qauniver.html “ . . . estimates for the number of atoms in our galaxy to be in the area of 10E68 a . . . there is a wide range of estimates given for the number of galaxies in the universe. Some put the number in the very low 100 billions, others bring it much closer to the one trillion (10E12) mark. The size of other galaxies range from one million to hundreds of billions of stars. The mass of some of the largest galaxies is trillions of times the mass of our sun. . . . Since our galaxy probably has no more than 10E69 atoms, this would mean that at most the universe contains 10E69×10E12 atoms in all.

This works out to just under 10E81. If we use lower estimates for the number of atoms in our galaxy and total number of galaxies, then the total number of atoms would be as much as 20 times less, or within the area of 10E79. Hence, “atoms in the universe . . . spans from 10E78 to just under 10E81.”

How effective would a 16 character RSID (3×10E38 unique values) relative to the number of currency items? What if we divided RSID's among the entire population of Earth:
7,000,000,000=7×10E9
3×10E38/7×10E9=4.28×10E28=42,800,000,000,000,000,000,000,000,000

That is how many unique RSID's combinations would be available to EACH person on Earth. Guess which ONE they choose for an RSID!

A supercomputer capable of 4.28×10E12 guesses per second 4.28×10E28/4.28×10E12=1×10E16/365 days×24 hours×3600 seconds=317×10E6=31 7,000,000 YEARS to guess each RSID available to ONE person on Earth! Good Luck!

The resulting benefit and application of these mathematical facts and estimates is that any attempts to counterfeit a variety of RSIDs are futile, as an item without a valid RSID is rejected by the Registration Authority. There is no point trying to fake multiple copies of a known RSID as when the RSID is investigated, it immediately becomes apparent as automatic computer calculations regarding known fake RSIDs, and probability factor simulations data is used involving time and distance are used to consider whether items require closer scrutiny.

Therefore it is also absolutely vital that all of the valid RSID's created for use the Registration Authority be kept secret by the Registration Authority, and furthermore, that any systems providing confirmation to any requesters (internal or external) are only given access to unalterable, immutable Master RSID Lists (for example on DVD-ROM disks) to mitigate and discourage computer system hacking to alter any RSID. Furthermore, RSIDs should be stored redundantly using more than one Master RSID List to ensure verifiable results and further mitigate computer hacking.

For example, five identical versions of a Master List of RSIDs stored on five separate computer systems that regularly compare their RSIDs to the other four RSID computer systems for RSID consensus would ensure overall RSID integrity and would require computer system hackers to penetrate at least three RSID computer systems to affect the majority “RSID computer majority consensus”. When we add the extra layer whereby each RSID is stored in an unalterable form, the integrity of the source RSID's becomes highly reliable.

The further use of secure telephone (e.g. call a secure, toll free local or national number), secure internet e-commerce encrypted SSL connections, and other secure communications systems further ensures the integrity of RSID and other data communications. The data search time can be further reduced if the top level of data storage is divided, for example (but not limited to) one prefix group of symbols for artwork, another for documents, another for electronic products, etcetera. Further subdivisions of similar items by their differences, for example (but not limited to) one subgroup for $5 currency notes, another for $10, etcetera. For example, but not limited to: commerce-currency-notes-twenty dollar-Canada which could be described as a Group Prefix for a unique collection the same Group Prefix for Canadian Twenty Dollar Currency Notes, whereby each note in the Group Prefix is assigned a unique, RSID.

To take advantage of this structure modification would require a standard prefix or suffix identifier(s) to signal that the following RSID is for a particular denomination, which would have to be consistently applied and implemented in RSID construction as well as retrieval methods.

Creating the RSID

Before creating RSIDs, we must first determine how many Items will be registered during the lifespan of the Registry. Then the number of symbols to use for this invention must be calculated, based on the number of currency items anticipated, perception of security desired for making the RSID extremely difficult to guess, balanced with the data storage needs, scanning error rate, computer processing error rate and extra communication required for having a large number of symbols for each RSID; as well as the anticipated volume of RSID's to be processed.

8.c.8. Furthermore, it is also necessary to ensure there is a large set of unique symbolic characters to choose from when randomly selecting and constructing the RSID. This can be accomplished by the methods and steps whereby computers run software employing rigorous mathematical concepts to first create large and varied sets of unique symbols, then assigning a unique binary value to each symbol of the set; followed by randomly selecting from the set of unique symbols for the purpose of assembling a unique group of symbols to comprise each RSID; The steps whereby a set of unique symbols is constructed is comprised of the steps of:
8.c.8.a. defining the maximum number of Random Symbolic Identifiers needed to ensure that any one RSID is unique and extremely difficult to guess.
8.c.8.b. calculating the minimum number of binary digits needed describe the maximum number of Random Symbolic Identifiers of step 8.c.8.a. (e.g. 20 binary digits is just over 1 million, 21 binary digits is 2 million=too much)
8.c.8.c. calculating the number of unique RSID symbols needed to enable generating a sufficient number of unique permutations of symbols to be assigned to each item of the group or the entire Registration Authority; (e.g. 2 letters A,B=4 unique permutations AA, AB, BA, BB which can be assigned to a maximum of 4 items)
8.c.8.d. creating a mathematically null, empty set of symbols;
8.c.8.e. constraining the set of claim 8.c.8.d. so that it will accept, contain, and emit only symbols capable of representation in two dimensions;
8.c.8.f. adding any number of symbols used in any written human language to the set of step 8.c.8.e.
8.c.8.g. adding any number of numeric symbols to the set of step .f.
8.c.8.h. creating a unique symbol comprising any combination of at least one shape; line, curve, arc or dots that can be expressed in two dimensional form;
8.c.8.i. adding any number of created symbols of step 8.c.8.h. to step 8.c.8.g
8.c.8.j. sorting, organizing, ordering and enumerating the symbols in the set of step 8.c.8.i.;
8.c.8.k. removing all identical symbols from the set of step 8.c.8.j.;
8.c.8.l. removing all similar symbols except for one from the set of step 8.c.8.k.; (e.g. letter O and number 0 can be easily confused so use just one)
8.c.8.m. further reducing or adding symbols as described previously to the set of step 8.c.8.l. so as to achieve the desired number of symbols of step 8.c.8.c. (to achieve the necessary diversity of symbols used to generate the required range of values to create unique, extremely difficult to guess, random symbolic identifiers);
8.c.8.n. assigning a unique binary value to each unique symbol in the set of step 8.c.8.m.
8.c.8.o. assigning a unique base ten number to each unique binary value of step 8.c.8.n;
8.c.8.p. assigning to this step, a unique set comprising of the set of 8.c.8.m. and the steps of 8.c.8.n. and 8.c.8.o.
8.c.9. The steps of assembling an RSID using a set of unique symbols obtained from step 8.c.8.p. for the purpose of making any currency item uniquely identifiable among currency items within a group of denominations or the entire Currency Registry Authority, comprising of at least the steps of:
8.c.9.a. creating a zero dimensional, mathematical series of symbols;
8.c.9.b. executing or running at least one computer program to perform a mathematically random selection of at least one symbol from the set of symbols of step 8.c.8.p.;
8.c.9.c. concatenating or inserting the symbol or group of symbols of step 8.c.9.b. into the series of step 8.c.9.a.;
8.c.9.d. enumerating or counting the number of symbols in the series of step 8.c.9.c.
8.c.9.e. repeating steps 8.c.9.c. followed by step 8.c.9.d. until the count of symbols equals the number of RSID symbols specified in step 8.c.9.c.
8.c.9.f. of making the Random Symbolic Identifier (RSID) identical and equal to the series of symbols generated according to steps 8.c.9.a. to 8.c.9.e.
8.c.9.g. concatenating each binary value in sequence for each RSID symbol of step 8.c.9.f. to create a unique binary number;
8.c.9.h. assigning a unique base 10 number to each unique binary number of step 8.c.9.g.;
8.c.9.i. assigning a unique barcode symbol to each unique RSID of 8.c.9.f. or 8.c.9.h.;
8.d. To facilitate computer processing, a unique barcode is generated for each unique RSID and correlated to the RSID;
8.e. To further reduce errors in computer processing a warning is included to reduce the amount of manual processing required.
8.f. To further reduce and detect errors, the RSID symbols are also scanned and compared to the RSID derived from the scanned barcode of 8.d. for corroboration of the RSID.

It is evident that those skilled in the art may now make numerous other uses and modifications of and departures from the specific embodiments described herein without departing from the inventive concepts. Consequently, this invention is to be construed as embracing each novel feature or novel combination of novel features present in or possessed by the methods and techniques herein disclosed and is not to be limited by the spirit or scope of appended claims.

### DEFINITIONS FOR THIS INVENTION

Registration Authority or Registration Authorities—any number of legally appointed and government approved group of people and/or equipment authorized to register Items and/or Events.

Master Registry—a repository of data to which registrations are sent for permanent storage and information retrieval.

Item—any number of things that can be perceived or detected, such as, but not limited to—any object having material form, any object having electronic or optical or electromagnetic or virtual representation, any concept or idea, any event, any time, any physical location;

### LIST OF FIGURES FOR THIS INVENTION

FIG. 1—a first embodiment of a site plan view for a denomination of currency being a Registered Item of this invention;

FIG. 2—a first embodiment of a data flow diagram for some Communications Methods of Registration of this invention;

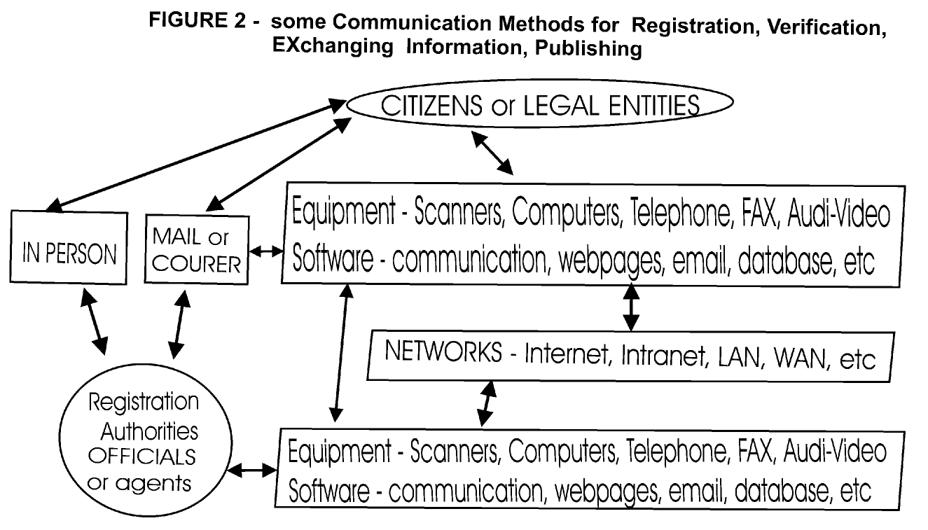

What is claimed is:

1. The steps and methods according to claims 1 to 20 whereby any number of Requestors make any number of requests to register any number of items submitted to any number of Registration Authorities; and the further step whereby each request is processed (such as, but not limited to: accepted, rejected, cancelled, deferred, suspended or ignored) any number of times, by any number of Registration Authorities.

2. The steps and methods according to claims 1 to 20 whereby for each request to register of claim 1, or, for each accepted request, information such as, (but not limited to) the item properties, characteristics, attributes, and ownership or special interests, are processed (such as, but not limited to :acquired, verified, recorded and stored) any number of times by the Registration Authority.

3. The steps and methods according to claims 1 to 20 whereby any number of unique Random Symbolic Identifier(s) (RSIDs) of claim 11, and any number of Sequential Symbolic Identifiers (SSIDs) of claim 12, and any number of Security Elements of claim 13, are assigned, embedded, linked, attached, integrated or otherwise directly associated with each Item being registered; and the further step whereby any number of retrievable markings (such as, but not limited to: barcodes, holographic image patterns, or electromagnetic field signal patterns) are correlated to each RSID or SSID or Security Element; and the further steps and methods whereby each Registration Authority that performs an item registration, provides at least one receipt to each registering entity requesting the registration (where a registering entity may be, but is not limited to—person(s), business(es), government(s), police, computer(s) running software program(s)) as well as any number of special interest entities such as, but not limited to—the police, government, by employing the steps and methods of (but not limited to) claims 1 to 20.

4. The steps and methods according to claims 1 to 20 whereby any number of entities (such as, but not limited to people or businesses) use any number of and combinations of devices or methods, such as, but not limited to—typed, printed, or handwritten forms, notes or letters, computers, telephones, facsimile machines, communications networks, computers running software programs, microprocessors, barcode scanners, magnetic field scanners, to acquire or receive, any number of RSIDs of claim 11, SSIDs of claim 12, or, Security Elements of claim 13, then sends, transmits or delivers in any form (such as, but not limited to: physical, electronic, electromagnetic, optical) using any methods (such as, but not limited to—postal mail, electronic mail, telephone, computer-internet) with any combination of additional processing (such as, but not limited to—registered mail, encryption, compression, encoding, packet pads), those requests to at least one Registration Authority (such as, but not limited to—police, government, business).

5. The steps and methods according to claims 1 to 20 whereby any number of Registration Authorities receives, translates, extracts, interprets, records, stores, evaluates, and replies, defers, denies or ignores any number of requests including the date and time of each request; and the further steps and methods whereby each request is sent any number of reply notices to the requester, and any number of notices are also sent to the owner or other special interest entities (such as, but not limited to—the police, government); and the further steps and methods for each valid request, whereby information regarding the Registered Item is sent to the requestor based upon the status (such as, but not limited to—anonymous, known, trusted, owner, police, government) assigned to the requestor, and any number of notices are also sent to any number of owners or any number of other special interest entities such as, but not limited to—the police, government.

6. The steps and methods according to claims 1 to 20 whereby for each request for information regarding any number of (but not limited to) Item RSIDs, SSIDs, or Security Elements, that the Item RSID, SSID or Security Element, as well as the origin of the request, are further analyzed any number of times, using any number of methods (such as, but not limited to—time, distance, counting, mathematics of statistics, algebra, calculus, distribution analysis, artificial intelligence, fuzzy logic, psychology of human behavior, travel logistics, human judgment), and the further steps and methods whereby the results of any number of analysis are recorded, stored, interpreted, summarized, or any other form of processing, and then transmitted, delivered or otherwise communicated to any number of entities, such as, but not limited to—police, owner(s), government(s), businesses.

7. The steps and methods according to claims 1 to 20 whereby for each Item RSID, SSID or Security Elements requests, from any number of entities, such as, but not limited to—computers, police, owner(s), government(s), businesses perform any number of appropriate actions, either immediately or at some later time or later time and date, or take no action whatsoever; and the further steps whereby any number of actions taken are reported to, and optionally recorded by any number of Registration Authorities, or any other entity such as, but not limited to, the police, government, owner, or business.

8. The steps and methods according to claims 1 to 20, whereby to protect the future privacy of the owners who transfer or sell items, for each Item that is sold to a new owner, when the new owner applies to re-register the Item, the new owner is assigned at least one completely new, private and confidential Item RSID, SSID or Security Element; and the further steps whereby the Registering Agency retains a record correlating the new Item RSID, SSID or Security Element to the previous Item RSID, SSID or Security Element; and the further step whereby only a limited number of entities (such as, but not limited to—the police) are given access to derive or determine the new Item RSID, SSID or Security Element by knowing the previous RSID, SSID or Security Element, or, the previous Item RSID, SSID or Security Element from the new RSID, SSID or Security Element.

9. The steps and methods according to claims 1 to 20, whereby all aspects of this invention shall also include the steps and methods of locating, detecting, acquiring, stimulating, reading, receiving, interpreting, translating, correcting, reporting, storing, and transmitting any number of, and any combination of—symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, holograms, images, holographic image patterns, synthetic or natural fibers, microscopic writing, any number of man-made devices or materials, any naturally occurring materials in any form of manifestation (such as, but not limited to—physical, electronic).

10. The steps and methods, according to claims 1 to 20, for any number of (but not limited to:) data signals, data elements, communications or data processing steps of this invention, (hereafter referred to as Information Elements), as well as any number of the steps and methods of Information Processing (such as, but not limited to—locating, receiving, detecting, extracting, filtering, sorting, organizing, monitoring, interpreting, translating, reporting, recording, storing, transmitting, verifying, correcting, verifying corrections, converting, modifying, enhancing, storing, retrieving, playback, encrypting, compressing, decompressing, decrypting, encoding, decoding), are applied any number of times, in any number of combinations, to any number of non-erroneous, erroneous, duplicate, or indeterminate Information Elements; and the further steps and methods whereby Information Processing is performed by any combination of (but not limited to)—any number of persons, at least one Registration Authority, any number of data acquisition devices, any number of computers and software programs, any number of microprocessors, any number of communication networks, any number of other man-made devices; and the further steps and methods for this invention, of transmitting data to, and receiving data from, any number of recipients such as, but not limited to—persons, man-made devices, communications networks; as well as the steps and methods of Information Processing being applied any number of times, to any number of man-made, naturally occurring or artificially created—device codes, languages, signals, data, concepts, reports or any other forms or manifestations of information, as well as applying Information Processing to any number of—modes, protocols or formats of Information Elements, Communication Elements (such as, but no limited to—network data packets, computer signals, facsimile machine signals, optical scanner signals, telephony signals, electromagnetic field signals) interpretation, intermediary results, transmission, reception, as well as, but not limited to processes of data reporting, including, but not limited to report preparation, assembly, composition, publication.

11. The steps and methods, according to claims 1 to 20, of generating, organizing, storing, locating, retrieving and communicating any number of Random Symbolic Identifiers (RSIDs) for this invention, and any other inventions claimed by the inventor, such that the RSID is manufactured to be extremely difficult to guess, by assembling a group (of a finite size or a variable size within predetermined range of sizes) of selected symbols from a standardized set of symbols, such that the RSID prevents anyone from easily guessing an RSID, or generating any number of valid RSIDs by simply by incrementing or decrementing the values used in the reference RSID they possess; and the further step whereby the RSID of this invention shall also include the provision to include any number of sequential series or any number of repeatable pattern of symbols, with an appropriate adjustment to this invention, including the understanding that the previously defined RSID would imply either a sequence or pattern for this invention document; and the further steps and methods of associating each symbol used to create any RSID or group prefix to a specific, unique binary digit combination; and the further steps of (but not limited to)—concatenating each binary digit in the same order as assembling the RSID, deriving and recording a unique binary and base 10 number for the concatenated binary digits, associating in a consistent manner a unique group of scanning symbols (such as, but limited to barcode) to each unique RSID or derived numeric value.

12. The steps and methods, according to claims 1 to 20, of generating, organizing, storing, locating, retrieving and communicating any number of Sequential Symbolic Identifiers (SSIDs) for this invention, and any other inventions claimed by the inventor, such that the SSID is manufactured to be a rational, logical, progression of symbols that is easy to determine (such as, but not limited to AA, AB or A1, A2) or numbers such as, but not limited to 11, 12), by assembling a group (of a finite size or a variable size within predetermined range of sizes) of selected symbols from a standardized set of symbols; and the further steps and methods of associating each symbol used to create any SSID to a specific, unique binary digit combination; and the further steps of (but not limited to)—concatenating each binary digit in the same order as assembling the SSID, deriving and recording a unique binary and base 10 number for the concatenated binary digits, associating in a consistent manner a unique group of scanning symbols (such as, but limited to barcode) to each unique RSID or derived numeric value; and the further steps and methods of assigning any number of SSIDs to any Item in any number of claims of this invention, or any other inventions claimed by the inventor; and the further steps of correlating each SSID to any number of RSIDs; and the further steps of assigning SSIDs instead of RSIDs to any number of Items of this invention or any other inventions claimed by the inventor.

13. The steps and methods, according to claims 1 to 20, whereby Security Elements of previous claims of this invention may consist of, but are not limited to—symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, holograms, images, holographic image patterns, synthetic or natural fibers, microscopic writing, any number of man-made devices or materials, any naturally occurring materials in any form of manifestation (such as, but not limited to—physical, electronic, electromagnetic, optical).

14. The steps and methods, according to claims 1 to 20 of attaching, embedding, integrating, printing, displaying, or publishing any number of RSIDs of claim 11, any number of SSIDs of claim 12, and any number of scanning symbols (such as, but not limited to—barcodes, magnetic field signatures) on the surface of, or inside physical or virtual objects; and the further steps and methods of correlating any number of scanning symbols to each RSID or SSID, concatenated binary digits and unique numeric value; and the further steps and methods of scanning any number of RSIDs or SSIDs and deriving the correct scanning symbols, concatenated binary digits and unique numeric value—any number of times for any number of scanning symbols, RSIDs or SSIDs; and the further steps and methods whereby to detect errors, the RSID or SSID symbols are scanned and compared to the RSID or SSID that was derived from the scanned barcode for corroboration of the derived RSID or SSID.

15. The steps and methods according to claims 1 to 20 of generating any number of RSID's, and any number of SID's, then storing them each RSID and each SSID on at least one unalterable permanent recording or storage device; and the further step of linking more than one copy of the permanent records together to enable enhanced accuracy by methods of performing activities such as, but not limited to—determining majority consensus, corruption detection, intrusion detection, and consistency monitoring; and the further steps and methods to exchange, convey, deliver, transmit or receive RSID's or SSID's, any number of times, with any number of authorized data originators or any number of data recipients, according to claims 1 to 14.

16. The steps and methods according to claims 1 to 20 of claiming the right to add to, clarify, amend, or delete this claim at a later date.

17. The steps and methods according to claims 1 to 20 of claiming the right to add to, clarify, amend, or delete this claim at a later date.

18. The steps and methods according to claims 1 to 20 of claiming the right to add to, clarify, amend, or delete this claim at a later date.

19. The steps and methods, according to claims 1 to 20, whereby any number of claims of this invention are applied to any number of public or private occurrences or instances of, but not limited to—instruments of commerce, business transactions, or legal activities, such as, but not limited to—currency, stocks, bonds, transactions, documents, licenses, certificates, or any other forms of documentation, data storage, data retrieval, data interpretation, data communications, data records of actions or events.

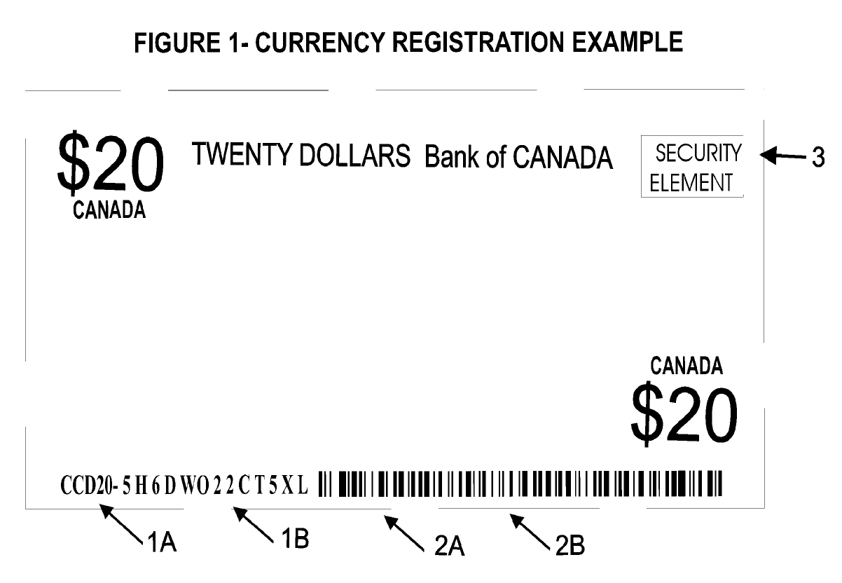

20. The steps and methods according to claims 1 to 20 whereby any number of claims of this invention are applied to the registration of any number of denominations of currency, originating from any number of nations (FIG. 1); and the further steps and methods whereby at least specific group prefix is assigned to each denomination for each nation (such as, but not limited to: CCD20CDN=commerce-currency-dollars-twenty-canada) (FIG. 1—item 1A); and the further steps and methods whereby at number of currency notes within any number of denominations for any number of nations is assigned any number of RSIDs of claim 11 (FIG. 1—item 1B), and any number of SSIDs of claim 12 (FIG. 1—item 1B); and the further steps of processing (such as, but not limited to—assigning, scanning, deriving, correlating) any number of groups of scannable symbols (such as, but not limited to—2 dimensional barcodes) for each specific group prefix (FIG. 1—item 2A) and each RSID or SSID (FIG. 1—item 2B) according to claims 9, 10, 11, 12, 13, 14, 15; and the further steps and methods such as but not limited to: storing, acquiring, deriving, retrieving, reporting and exchanging information according to claims 1 to 20.
